(19) United States
(12) Patent Application Publication
(10) Pub. No.: US 2024/0076179 A1
(43) Pub. Date: Mar. 7, 2024

(54) AUTOMATED FOUNTAIN BEVERAGE DISPENSING SYSTEM

(71) Applicants: SOYKAN DIRIK, Laguna Niguel, CA (US); MEHMET KAPTANA, Irvine, CA (US)

(72) Inventors: SOYKAN DIRIK, Laguna Niguel, CA (US); MEHMET KAPTANA, Irvine, CA (US)

(21) Appl. No.: 17/721,208

(22) Filed: Apr. 14, 2022

Related U.S. Application Data
(60) Provisional application No. 63/174,771, filed on Apr. 14, 2021.

(51) Int. Cl. B67D 1/08; B25J 11/00; B25J 15/06; B25J 15/08

(52) U.S. Cl. CPC B67D 1/0894; B25J 11/0045; B25J 15/0616; B25J 15/08; B67D 1/0888

(57) ABSTRACT

The present invention discloses a beverage dispenser attachment that simulates human movement thereby allowing automation of beverage dispensing activity.

### FIELD OF THE INVENTION

The present invention belongs to the field of beverage dispensing systems. More particularly, the present invention relates to a beverage dispenser attachment that simulates human movement thereby allowing automation of beverage dispensing activity.

### BACKGROUND OF THE INVENTION

Automated beverage dispensing systems are known in the art. For example, U.S. Pat. No. 9,994,340 discloses an automated beverage dispenser for dispensing beverage and ice into a cup.

Beverage dispensing systems are located in the areas accessible to the crew members or the customers of a restaurant and have features like pre-determined portion control for amount of beverage dispensed for a particular cup size. As a result, the person handling the beverage dispensing system may be: i) a crew member of the restaurant, or ii) a customers of the restaurant. Commonly, the person handling the beverage dispensing system may take an order, then manually pull a cup, may or may not add ice to the cup depending on the order, and then place the cup under the nozzle of the beverage dispensing system, which then dispenses a beverage to fill the cup as per the order at the press of a valve. Based on the type of the valve present in the beverage dispensing system, beverage is filled either manually, by the said person deciding on the amount of beverage to dispense, or automatically where the said person presses a cup-size button on the valve so that a predetermined amount of beverage is dispensed. Another popular method of automatically dispensing beverages is where the person handling the beverage dispensing system places the cup under the nozzle and the cup is filled to the top, and the valve stops dispensing beverage upon detecting overflow. Current invention discloses a robotic arm that simulates all these human movements.

Importantly, the current invention is not a separate automated beverage dispenser. On the contrary, the current invention discloses an attachment comprising a robotic arm capable of simulating human movement, whereby the said attachment is mounted on an already existing beverage dispenser, and the simulation of human movement by the said robotic arm allows the automation of beverage dispensing process. The current invention disclosing only an attachment, and not a full scale automated beverage dispenser, allows capital savings.

### DESCRIPTION OF THE DRAWINGS

FIG. 1 is a perspective view showing an automation system mounted to a side of a beverage dispensing system, as per an embodiment of the present invention.

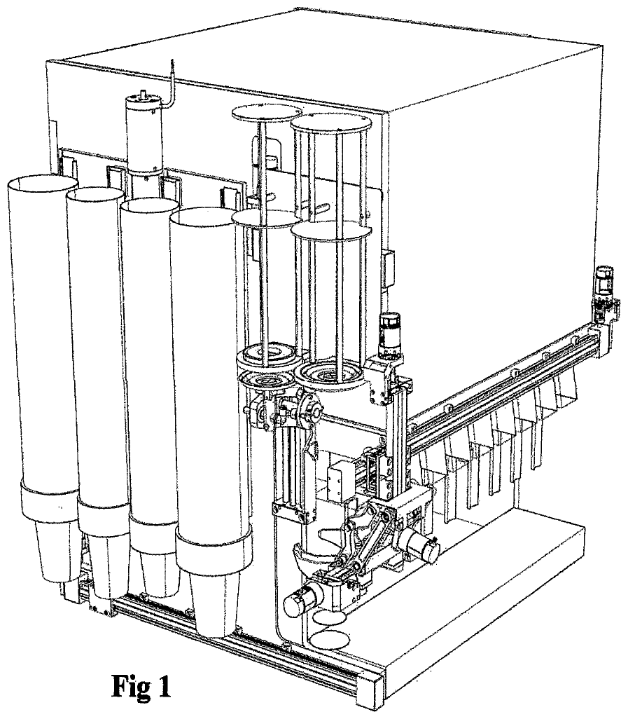

FIG. 2 is a perspective view showing a cup being taken from cup dispensers as per an embodiment of the present invention.

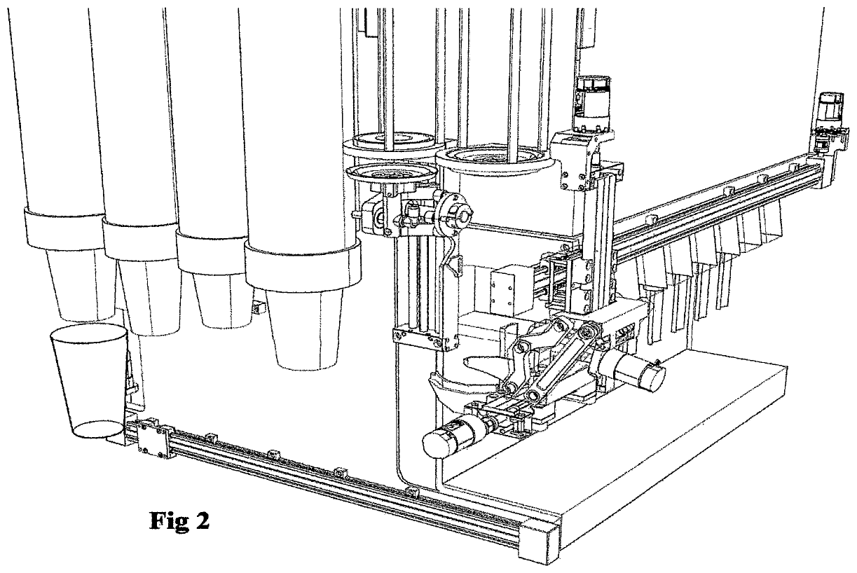

FIG. 3 is a perspective view showing robotic arm grabbing the cup as per an embodiment of the present invention.

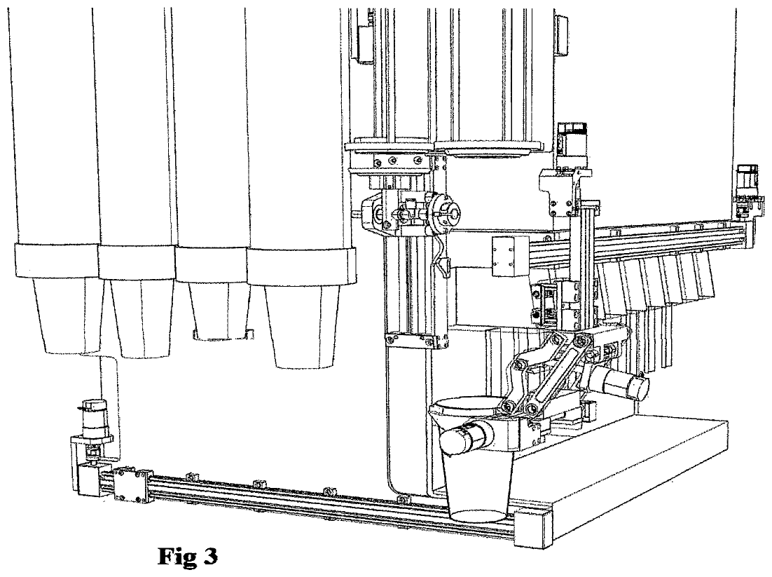

FIG. 4 is a perspective view showing movement of a cup to fill ice as per an embodiment of the present invention.

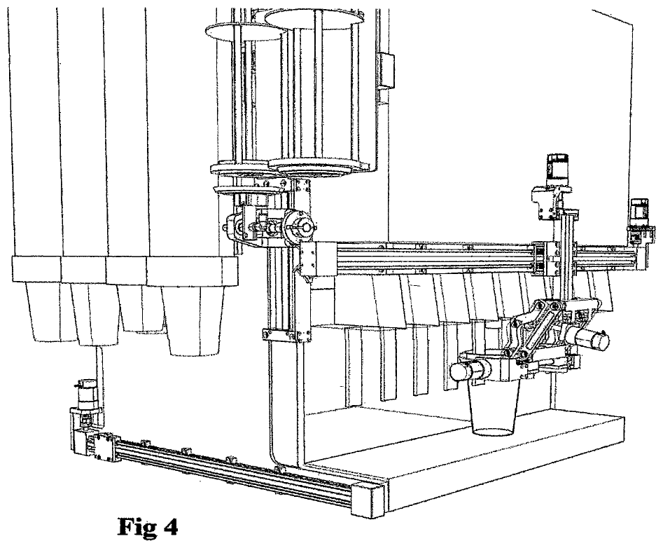

FIG. 5 is a perspective view showing movement of a cup to fill beverage as per an embodiment of the present invention.

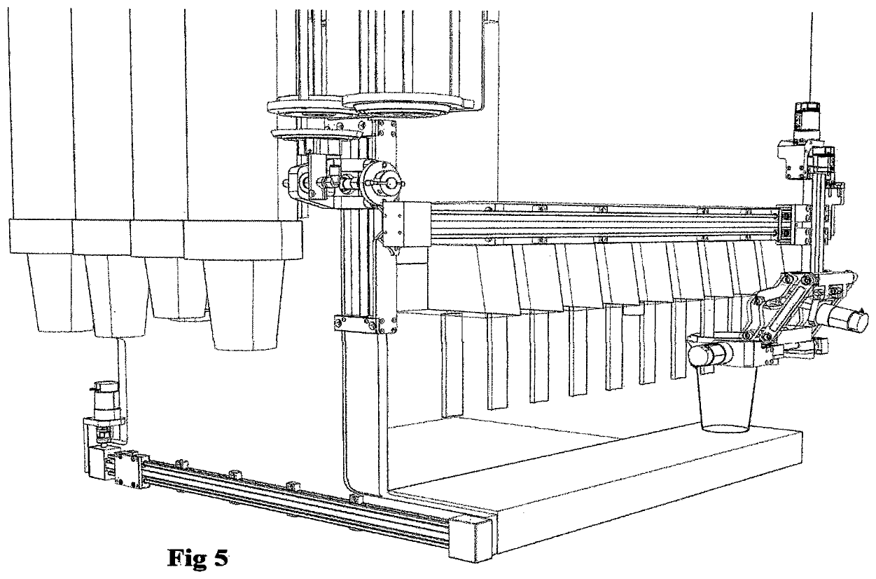

FIG. 6 is a perspective view showing the lid being closed as per an embodiment of the present invention.

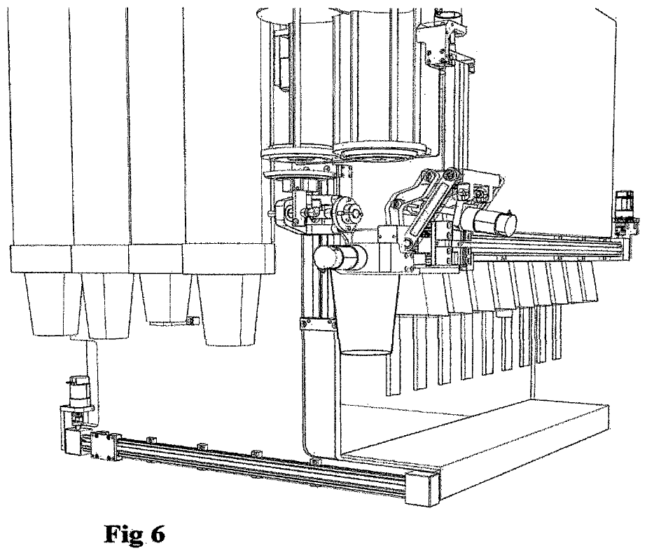

FIG. 7 is a perspective view showing movement of a cup to the parking area as per an embodiment of the present invention.

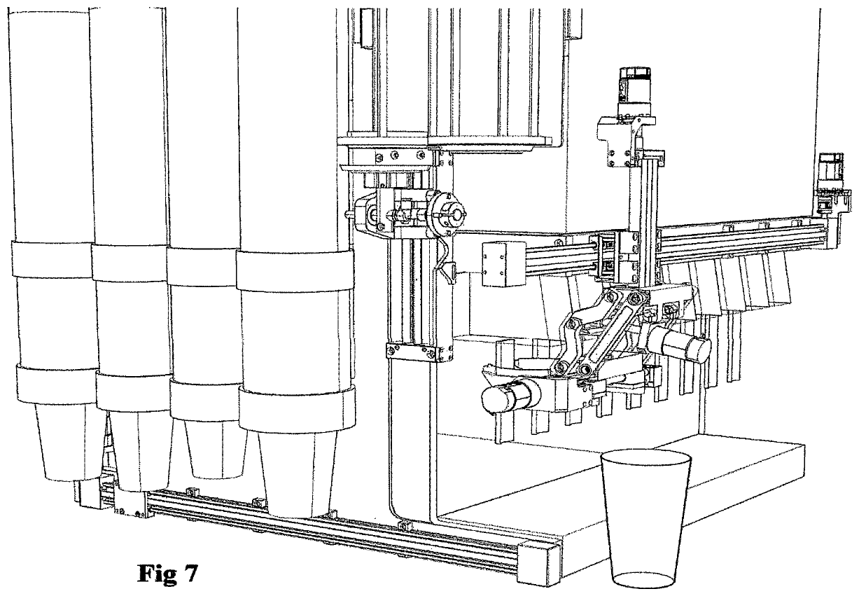

FIG. 8 is a perspective view showing multiple cups being filled simultaneously as per an embodiment of the present invention.

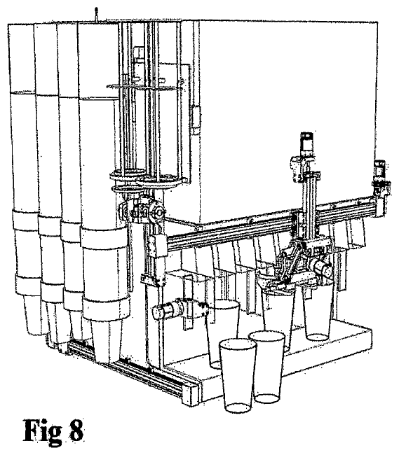

### DESCRIPTION OF THE INVENTION

The following description is presented to enable any person skilled in the art to make and use the invention, and is provided in the context of particular applications of the invention and their requirements. The present invention can be configured as follows:

The attachment disclosed by the present invention comprises a robotic arm.

Robotic beverage dispensers are known in the art. For example, US 2006 0043111 discloses a robotic beverage server configured to take a beverage order, prepare the beverage or mixture of beverages, and serve the beverage to a consumer.

The current invention is distinguished from existing art in multiple points.

First, the current invention is not a separate beverage dispenser machine on its own. In other words, the current invention does not have a cooler, a noozle, or other parts that exist on a conventional beverage dispenser. The current invention is an attachment that is mounted on an existing beverage dispenser. The disclosed attachment comprises a robotic arm which simulates human movement through robotic principles.

Therefore, the current invention is distinguished from U.S. Pat. No. 9,994,340 and US 2006 0043111.

Second, current invention can close lids. In the art, closing lids is a technical problem not addressed. For example, U.S. Pat. No. 5,350,082 discloses a money activated beverage dispensing line in which the dispensing of a beverage from a series of dispensing stations is automatically controlled with consumer interaction. On the other hand, current invention can disclose lids because the robotic arm can simulate human movement.

Therefore, the current invention is distinguished from U.S. Pat. No. 5,350,082.

Third, the current invention follows a model and an algorithm which allows the optimization of process time. In specific, current invention does not comprise a carousel and on the contrary comprises a robotic arm. This allows the current invention to deviate from first in first out and to follow a model and an algorithm. For example, US 2005 0150399 discloses a device used for automatically marking beverage containers receiving beverages from a conventional drink dispenser, comprising a carousel, which means process time cannot be optimized. In specific, the nozzle velocity is the limiting factor for process time in most instances because increased nozzle speed causes bubbling. As a result, there is an upper limit for nozzle velocity. This upper limit on nozzle velocity is generally around 4 to 5 ounces per second. Current invention can process multiple cups because the model and the algorithm followed allows the robotic arm to handle additional cups while one cup is being filled.

Therefore, the current invention is distinguished from US 2005 0150399.

Fourth, the current attachment can be mounted or dismounted any time. Furthermore, the current attachment may be turned off, without being dismounted, by an operator any time, while the underlying beverage dispenser continues to be operated by a human manually.

Therefore, the current invention is distinguished from all prior art mentioned above.

The automation system in the current invention is connected to an order system of a restaurant. The automation system can be connected to the order system using any of a wired connection or a wireless connection. The order system can be any of one managed by a crew member of a restaurant or a self-serve ordering system accessible to customers of a restaurant.

As per a preferred embodiment of the present invention the automation system comprises an order information receiving component which receives information from the order system about an order of beverages placed by a customer. The information comprises beverage details, ice requirements and cup sizes such as child, small, medium, large or extra-large cups. An order may comprise multiple beverages of different types, mixes of the beverage or flavoring (flavor shots), as well as different cup sizes for each beverage type. The order may also mention the amount of ice for each of the beverages ordered.

The disclosed robotic arm takes a cup from an array of cups, stacked in separate columns as per cup sizes, corresponding to one of the cup sizes in the order placed by a customer. Cups are pulled by vacuum nozzle or by gripper. Cups are either pulled down or cup holders are raised up gripping only one cup. The cup is moved to the robotic arm gripper on a linear rail. Thereafter, the robotic arm delivers the cup under a nozzle. The robotic arm initially fills the cup with ice, if ordered, and then beverages. Once the cup has been filled with ice as per the order placed by the customer, the robotic arm moves the cup under a nozzle of the beverage dispensing system. Once the cup has been filled with the beverage, the robotic arm moves the cup to a lid station. There are up to 3 sizes of lids stocked upside down. The appropriate size lid is pulled from the lid dispenser with vacuum or mechanical action, turned and pushed down on the cup. Another method of closing the lid is sweeping the lid on the cup by pulling the cup under a bar. After the lid is closed, the fill robotic arm moves the cup to a serving station from where the cup can be collected by a customer or a crew member of the restaurant. There are displays over each cup showing the order number, a color code (optionally can be matching vehicle color), the drink flavor, the size, and the amount of ice. Furthermore, there is a light that beams color on top of the cup. Furthermore, this beam of color light flashes if drink is diet drink, ensuring the diet drinks are properly served to potentially diabetic customers.

There are sensors on top of the cups, sending signals to the system when each serving station is occupied or empty. Robotic arm then delivers new order to empty serving stations.

The present invention discloses that the automation system can be enabled to dispense, move and fill multiple cups at the same time, where each cup could be of same or different size as well as each cup may have same or different beverage and ice requirements.

As per a preferred embodiment of the present invention, the automation system is detachable, and can be mounted to any existing beverage dispensing systems where the various components of the automation system can be removably attached to the required components of the existing beverage dispensing system and the existing order system of a restaurant. It can be easily understood and appreciated by any person skilled in the art that the automation system of the present invention can both be removably mounted to a new beverage dispensing system as well as can be made an integral part of a new beverage dispensing system. As per this, any person skilled in the art would easily understand that the beverage dispensing system can be used on its own, without the automation system. Further, if needed, orders can be entered manually on an embedded screen on the automation system.

As per another embodiment of the present invention, the automation system may display one or more order details on an embedded screen. The order details being displayed may include, but not limited to, the type of the drink being prepared at a moment, number of drinks in an order, ice requirements, and cup size.

As per an embodiment of the present invention, the automation system can work in sync with the existing point-of-sale (POS) system based on the order received, where the beverage dispensing system is equipped to dispense ice and beverages without any manual inputs. Existing point-of-sale (POS) system cen be directly integrated to the automated fountain beverage dispensing system disclosed herein.

As per another embodiment of the present invention, the automation system can work in sync with the existing point-of-sale (POS) system based on the order received, where the beverage dispensing system is equipped to dispense ice and beverages only with manual inputs. In such a case the automation system would be capable of providing the manual inputs to the beverage dispensing system. In this particular case, any required manual inputs to dispense ice and/or beverages can be provided by the automation system.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features herein before set forth.

Further it will be apparent to those skilled in the art that the objects of the present invention have been achieved by providing the above invention. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Therefore, the scope of the invention is to be determined by the terminology of the above description and the legal equivalents thereof.

The invention claimed is:

1. A robotic arm mounted on an already existing beverage dispenser as an attachment, and not a full scale automated beverage dispenser, wherein the robotic arm simulates human movement through robotic principles for the automation of beverage dispensing activity.

2. The robotic arm of claim 1, wherein the robotic arm takes a cup from cup dispensers by grabbing the cup.

3. The robotic arm of claim 2, wherein cups are pulled by a vacuum nozzle or by a gripper.

4. The robotic arm of claim 2, wherein cups are either pulled down or cup holders are raised up gripping only one cup and the cup is moved to the robotic arm gripper on a linear rail.

5. The robotic arm of claim 1, wherein the robotic arm fills ice to the cup.

6. The robotic arm of claim 5, wherein the robotic arm simultaneously fills ice to several cups.

7. The robotic arm of claim 1, wherein the robotic arm fills beverage to the cup.

8. The robotic arm of claim 6, wherein the robotic arm simultaneously fills beverage to several cups.

9. The robotic arm of claim 1, wherein the robotic arm closes the lid of the filled cup, which may optionally also have ice.

10. The robotic arm of claim 1, wherein the robotic arm closes the lid of the filled cup by sweeping the lid on the cup and later by pulling the cup under a bar.

11. The robotic arm of claim 1, wherein the robotic arm moves the filled cup, which may optionally also have ice, and is closed by a lid to the parking area.

12. The robotic arm in any one of the claims above, wherein the beverage dispenser does not comprise a carousel thereby a model and an algorithm optimizes process time.
